(19) United States
(12) Patent Application Publication
(10) Pub. No.: US 2023/0244564 A1
(43) Pub. Date: Aug. 3, 2023

(54) SYSTEMS AND METHODS FOR PROACTIVELY STAGING PREBOOT FIRMWARE COMPONENTS FOR OFFLINE UPDATE AND REMEDIATION

(71) Applicant: Dell Products L.P., Round Rock, TX (US)

(72) Inventors: Jacob MINK, Austin, TX (US); Balasingh Ponraj SAMUEL, Round Rock, TX (US); Michael W. ARMS, Copperas Cove, TX (US)

(73) Assignee: Dell Products L.P., Round Rock, TX (US)

(21) Appl. No.: 17/590,350

(22) Filed: Feb. 1, 2022

(51) Int. Cl. G06F 11/07; G06F 8/65; G06F 9/4401

(52) U.S. Cl. CPC G06F 11/0793; G06F 8/66; G06F 9/4401

(57) ABSTRACT

An information handling system may include a processor, a memory communicatively coupled to the processor, and a basic input/output system (BIOS) communicatively coupled to the processor and comprising a program of executable instructions configured to, when read and executed by the processor: monitor diagnostics information associated with one or more information handling resources of the information handling system, from the diagnostics information, determine whether a trigger point associated with a prescription for initiating a firmware update has been reached, and responsive to the trigger point being reached, perform a remedial action as defined by the prescription.

### TECHNICAL FIELD

The present disclosure relates in general to information handling systems, and more particularly to systems and method for proactively staging preboot firmware components for offline update and remediation.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A critical component of modern information handling systems is the BIOS. A BIOS may comprise boot firmware configured to be the first code executed by a processor of an information handling system when the information handling system is booted and/or powered on, and serves to initialize information handling resources of the information handling system and/or initialize interoperation of the information handling system with other information handling systems. In addition to BIOS, an information handling system may include critical firmware for one or more other components of the information handling system.

Existing approaches for updating firmware, whether for BIOS or another component, are often complicated for end users, as such approaches may require a system reboot, network connection, and operating system environment transition (e.g., a payload transfer from an operating system environment to a preboot environment). As of the date of filing of this application, all firmware updates are typically initiated or promoted from an operating system environment. Thus, if an information handling system is unable to boot to an operating system, then either a network connection may be required or the end user may need to download the firmware update image from another computer in order to make the update.

Applicant has found that new firmware adoption rates within the industry is very low, as end users often postpone firmware updates due to the complexity. In fact, the new firmware adoption rate six months after a firmware update is often less than one-half. Due to this low adoption rate, information handling systems may miss out on important bug fixes, features updates, and security updates, which may lead to increased support costs and quality control issues. Further, when an information handling system experiences a boot problem (which may be related to a firmware issue), it may already be too late to update firmware from an operating system environment or backend server, and may require a costly repair at a repair center.

### SUMMARY

In accordance with the teachings of the present disclosure, the disadvantages and problems associated with existing approaches to firmware updating may be reduced or eliminated.

In accordance with embodiments of the present disclosure, an information handling system may include a processor, a memory communicatively coupled to the processor, and a basic input/output system (BIOS) communicatively coupled to the processor and comprising a program of executable instructions configured to, when read and executed by the processor: monitor diagnostics information associated with one or more information handling resources of the information handling system, from the diagnostics information, determine whether a trigger point associated with a prescription for initiating a firmware update has been reached, and responsive to the trigger point being reached, perform a remedial action as defined by the prescription.

In accordance with these and other embodiments of the present disclosure, a method may include, in a basic input/output system (BIOS) of an information handling system: monitoring diagnostics information associated with one or more information handling resources of the information handling system, from the diagnostics information, determining whether a trigger point associated with a prescription for initiating a firmware update has been reached, and responsive to the trigger point being reached, performing a remedial action as defined by the prescription.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to: monitor diagnostics information associated with one or more information handling resources of an information handling system, from the diagnostics information, determine whether a trigger point associated with a prescription for initiating a firmware update has been reached, and responsive to the trigger point being reached, perform a remedial action as defined by the prescription.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for proactively staging preboot firmware for offline update and remediation, in accordance with embodiments of the present disclosure;

FIG. 2 illustrates example contents of a prescription payload, in accordance with embodiments of the present disclosure; and

FIG. 3 illustrates a flowchart of an example method for proactively staging preboot firmware for offline update and remediation, in accordance with embodiments of the present disclosure.

### DETAILED DESCRIPTION

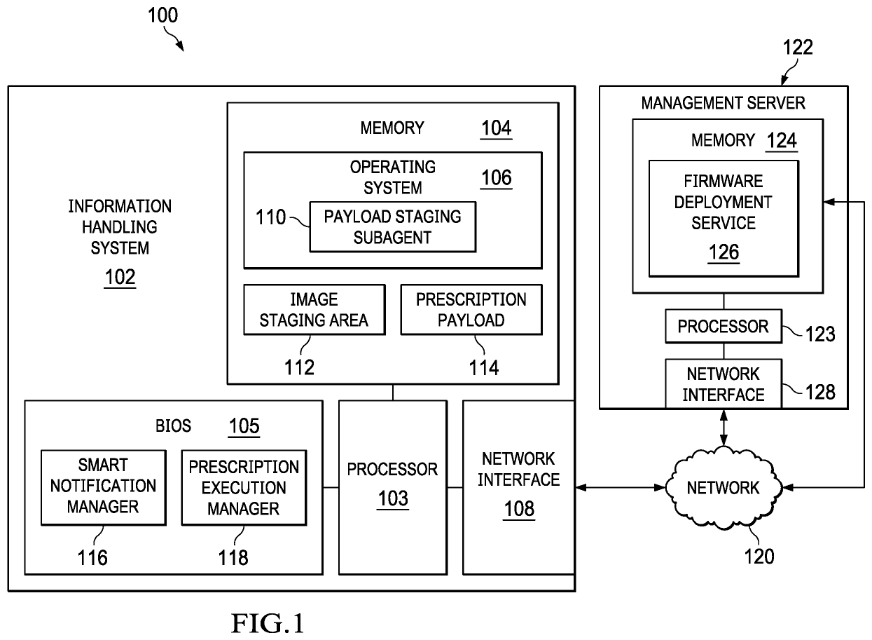

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 for proactively staging preboot firmware for offline update and remediation of an information handling system 102, in accordance with embodiments of the present disclosure. As shown in FIG. 1, system 100 may include information handling system 102, network 120, and management server 122.

In some embodiments, an information handling system 102 may comprise a personal computer. In some embodiments, an information handling system 102 may comprise or be an integral part of a server. In other embodiments, an information handling system 102 may comprise a portable information handling system (e.g., a laptop or notebook, etc.). As depicted in FIG. 1, an information handling system 102 may include a processor 103, a memory 104 communicatively coupled to processor 103, a BIOS 105 communicatively coupled to processor 103, and a network interface 108 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

As shown in FIG. 1, operating system 106 may have embodied therein a payload staging subagent 110. Payload staging subagent 110 may comprise any suitable program of instructions that is a component of operating system 106 or an application program configured to run on operating system 106, and may be configured to, when read and executed by processor 103, proactively stage firmware components to an image staging area 112, as described in greater detail below. Payload staging subagent 110 may also be configured to, when read and executed by processor 103, obtain prescription payload information from a management server 122 and store such information as a prescription payload 114, as described in greater detail below. In some embodiments, payload staging subagent 110 may poll management server 122 for prescription payload information in a “pull” arrangement. In these and other embodiments, management server 122 may initiate transfer of prescription payload information to payload staging subagent 110 in a “push” arrangement.

Image staging area 112 may comprise any suitable non-volatile, preboot-accessible portion of memory 104. For example, image staging area 112 may include or may be a part of a Non-Volatile Memory Enhanced (NVMe) boot partition, Extensible Firmware Interface (EFI) system partition (ESP), or designated Serial Peripheral Interface (SPI) storage.

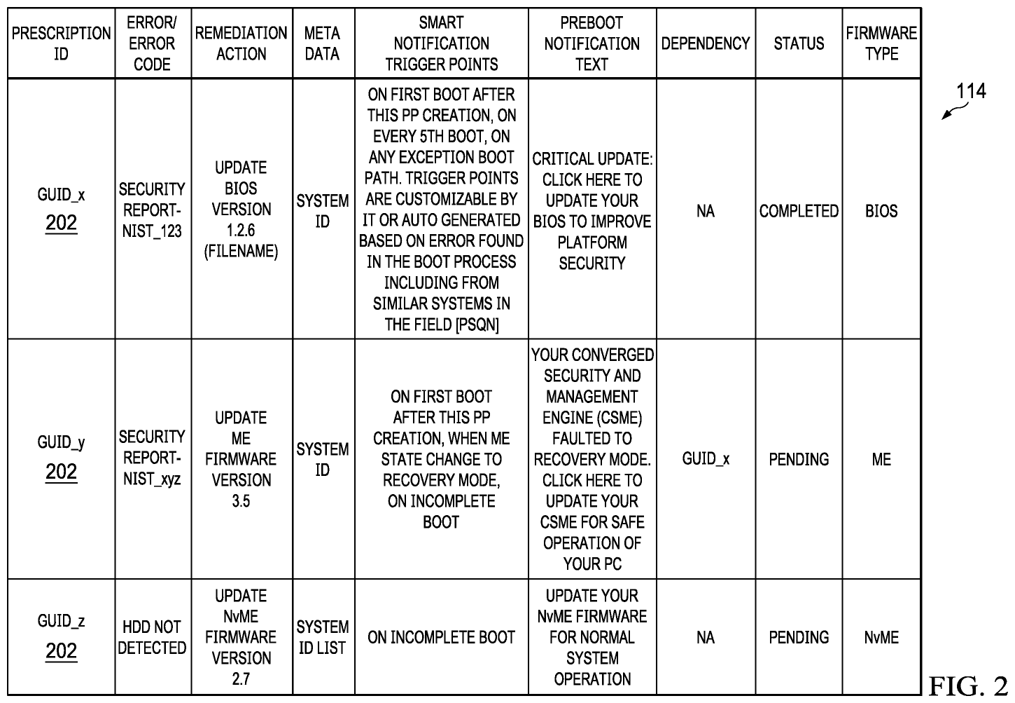

Prescription payload 114 may be stored in any suitable non-volatile, preboot-accessible portion of memory 104. For example, prescription payload 114 may be stored in an NVMe boot partition, ESP, or designated SPI storage. Prescription payload 114 may comprise a table, list, map, or other suitable data structure that sets forth one or more prescriptions for initiating a firmware update, wherein each prescription may include a prescription identifier (ID), an associated error/error code, an associated remedial action, associated metadata, a trigger point for a smart notification associated with the prescription, preboot notification text associated with the prescription, dependencies on one or more other prescriptions, a completion status, and/or a firmware type (e.g., BIOS firmware, management engine (ME) firmware, NVMe firmware, etc.). FIG. 2 illustrates example prescriptions 202 set forth in an example prescription payload 114, in accordance with embodiments of the present disclosure.

Turning back to FIG. 1, BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102. As shown in FIG. 1, BIOS 105 may implement a smart notification manager 116 and a prescription execution manager 118.

Smart notification manager 116 may comprise a program of instructions configured to, when read and executed by processor 103, monitor telemetry information associated with firmware executing on various components of information handling system 102 (e.g., via BIOS IQ) and in response to detecting a trigger within such telemetry information that is set forth in a prescription 202 of prescription payload 114, communicate a smart notification as set forth in the prescription 202, and in response to user action and/or an administrative policy for information handling system 102, cause prescription execution manager 118 to perform an offline update and/or remediation of firmware, as described in greater detail below.

Prescription execution manager 118 may comprise a program of instructions configured to, when read and executed by processor 103, perform an offline update and/or remediation of firmware, as described in greater detail below.

Network interface 108 may comprise any suitable system, apparatus, or device operable to serve as an interface between information handling system 102 and one or more other information handling systems via an in-band management network. Network interface 108 may enable information handling system 102 to communicate using any suitable transmission protocol and/or standard. In these and other embodiments, network interface 108 may comprise a network interface card, or “NIC.” In some embodiments, network interface 108 may comprise a 10 gigabit Ethernet network interface. In these and other embodiments, network interface 108 may be enabled as a local area network (LAN)-on-motherboard (LOM) card. Network interface 108 may be configured to communicate via wire-line transmissions, wireless transmission, or both.

In addition to processor 103, memory 104, BIOS 105, and network interface 108, information handling system 102 may include one or more other information handling resources.

Network 120 may be a network and/or fabric configured to couple information handling system 102, management server 122, and/or one or more other information handling systems to one another. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

Management server 122 may comprise any information handling system including requisite hardware, software, and/or firmware for interfacing information handling system 102 via network 120 in order to perform end-to-end workload modeling, as described in greater detail below.

As depicted in FIG. 1, management server 122 may include a processor 123, a memory 124 communicatively coupled to processor 123, and a network interface 128 communicatively coupled to processor 123. Processor 123 may include any system, device, or apparatus configured to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 123 may interpret and/or execute program instructions and/or process data stored in memory 124 and/or another component of management server 122.

Memory 124 may be communicatively coupled to processor 123 and may include any system, device, or apparatus configured to retain program instructions and/or data for a period of time (e.g., computer-readable media). Memory 124 may include RAM, EEPROM, a PCMCIA card, flash memory, magnetic storage, opto-magnetic storage, or any suitable selection and/or array of volatile or non-volatile memory that retains data after power to management server 122 is turned off.

As shown in FIG. 1, memory 124 may have a firmware deployment service 126 stored thereon. Firmware deployment service 126 may comprise any suitable program of instructions configured to, when loaded by processor 123 from memory 124, manage deployment of firmware images to image staging area 112 and deployment of prescription payload 114 to information handling system 102 via network 120, as set forth in greater detail below. For example, in some embodiments, a prescription payload 114 by be generated statically by a system engineering team when firmware is published to firmware deployment service 126. As another example, in these and other embodiments, prescription payload 114 may be generated based on telemetry data (e.g., telemetry tools executing on operating system 106 of information handling system 102 and executing on operating systems of other information handling systems, BIOS IQ tools executing on BIOS 105 of information handling system 102 and executing on BIOSes of other information handling systems). As a specific example, prescription payload 114 may be created using one or more error codes provided by BIOS IQ telemetry executing on BIOS 105 or other BIOSes. In any event, firmware deployment service 126 or another service may cryptographically sign prescription payload 114 (e.g., with a private key of a public-private key pair) such that prescription payload 114 may be authenticated by smart notification manager 116 and/or prescription execution manager 118 (e.g., by using a public key of the public-private key pair). Further, firmware deployment service 126 may cause a firmware update image to be communicated to information handling system 102 via network 120 in response to the firmware update image being published to firmware deployment service 126. In addition, firmware deployment service 126 may cause prescription payload 114 to be communicated to information handling system 102 via network 120, once generation of prescription payload 114 is complete.

Network interface 128 may comprise any suitable system, apparatus, or device operable to serve as an interface between management server 122 and network 120. Network interface 128 may enable management server 122 to communicate using any suitable transmission protocol and/or standard, including any of the protocols and/or standards described above with respect to network 120. In these and other embodiments, network interface 128 may comprise a NIC.

In addition to information handling system 102, network 120, and management server 122, system 100 may include one or more other information handling resources.

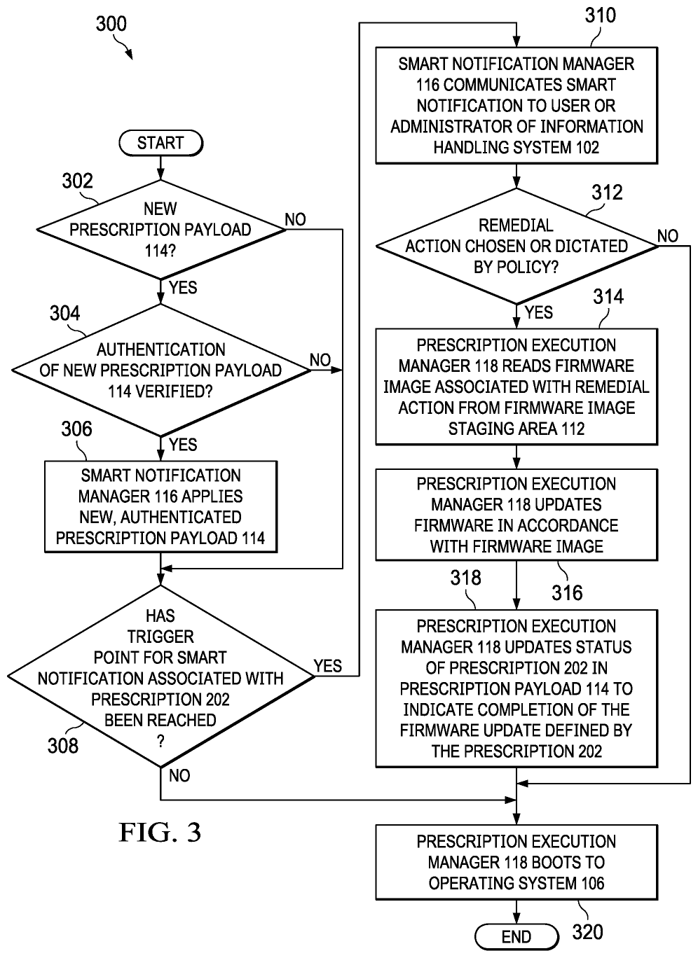

FIG. 3 illustrates a flowchart of an example method 300 for proactively staging preboot firmware for offline update and remediation, in accordance with embodiments of the present disclosure. According to certain embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, during preboot execution of BIOS 105, smart notification manager 116 may determine if there is a new prescription payload 114 (e.g., an update of prescription payload 114 with new prescriptions 202). If there is a new prescription payload 114, method 200 may proceed to step 304. Otherwise, method 300 may proceed to step 308.

At step 304, smart notification manager 116 may verify authentication of the new prescription payload 114. If the new prescription payload 114 is authenticated, method 300 may proceed to step 306. Such authentication may be performed in any suitable manner. For example, in some embodiments, management server 122 may sign prescription payload 114 with a private key of a public-private key pair, and smart notification manager 116 may verify by applying a public key of the public-private key pair. Otherwise, method 300 may proceed to step 308 with use of an existing, authenticated prescription payload 114.

At step 306, smart notification manager 116 may apply the new, authenticated prescription payload 114.

At step 308, smart notification manager 116 may monitor diagnostics (e.g., from BIOS IQ) to determine if a trigger point for a smart notification associated with a prescription 202 has been reached. If a trigger point has been reached, method 300 may proceed to step 310. Otherwise, method 300 may proceed to step 320.

At step 310, in response to the trigger point being reached for a prescription 202, smart notification manager 116 may communicate a smart notification, as set forth in the prescription 202, to a user or administrator of information handling system 102.

At step 312, smart notification manager 116 may determine if the user or administrator chose to execute the remedial action set forth in the prescription 202 or if a policy associated with the information handling system 102 dictates execution of the remedial action. If remedial action has been chosen or dictated by policy, method 300 may proceed to step 314. Otherwise, method 300 may proceed to step 320.

At step 314, prescription execution manager 118 may read a firmware image associated with the remedial action from firmware image staging area 112. At step 316, prescription execution manager 118 may update firmware in accordance with the firmware image. In the case that a particular remedial action is indicated by prescription 202 to be dependent upon another prescription, prescription execution manager 118 may also update firmware in accordance with such dependency. At step 318, after completion of the firmware update, prescription execution manager 118 may update a status of prescription 202 in prescription payload 114 to indicate completion of the firmware update defined by the prescription 202.

At step 320 prescription execution manager 118 may boot to operating system 106. After completion of step 320, method 300 may end.

Although FIG. 3 discloses a particular number of steps to be taken with respect to method 300, it may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using information handling system 102, components thereof or any other system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a memory communicatively coupled to the processor; and
a basic input/output system (BIOS) communicatively coupled to the processor and comprising a program of executable instructions configured to, when read and executed by the processor:
monitor diagnostics information associated with one or more information handling resources of the information handling system;
from the diagnostics information, determine whether a trigger point associated with a prescription for initiating a firmware update has been reached; and
responsive to the trigger point being reached, perform a remedial action as defined by the prescription.

2. The information handling system of claim 1, wherein performing the remedial action comprises:
responsive to the trigger point being reached, communicating a notification defined by the prescription to a person;
determining whether the remedial action is chosen by the person or dictated by a policy of the information handling system; and
responsive to the remedial action being chosen by the person or dictated by the policy of the information handling system, performing the remedial action.

3. The information handling system of claim 1, wherein the remedial action comprises application of a firmware update to an information handling resource of the information handling system.

4. The information handling system of claim 3, wherein the information handling resource is the BIOS.

5. The information handling system of claim 3, wherein a firmware update image for performing the firmware update is staged in a non-volatile, preboot-accessible portion of the memory.

6. The information handling system of claim 5, wherein the firmware update image for performing the firmware update is retrieved from a firmware deployment service remotely networked to the information handling system and staged in the non-volatile, preboot-accessible portion of the memory until the firmware update is applied.

7. The information handling system of claim 1, wherein the prescription is set forth in a prescription payload comprising one or more prescriptions and stored in a non-volatile, preboot-accessible portion of the memory.

8. A method comprising, in a basic input/output system (BIOS) of an information handling system:
monitoring diagnostics information associated with one or more information handling resources of the information handling system;
from the diagnostics information, determining whether a trigger point associated with a prescription for initiating a firmware update has been reached; and
responsive to the trigger point being reached, performing a remedial action as defined by the prescription.

9. The method of claim 8, wherein performing the remedial action comprises:
responsive to the trigger point being reached, communicating a notification defined by the prescription to a person;
determining whether the remedial action is chosen by the person or dictated by a policy of the information handling system; and
responsive to the remedial action being chosen by the person or dictated by the policy of the information handling system, performing the remedial action.

10. The method of claim 8, wherein the remedial action comprises application of a firmware update to an information handling resource of the information handling system.

11. The method of claim 10, wherein the information handling resource is the BIOS.

12. The method of claim 10, further comprising staging a firmware update image for performing the firmware update in a non-volatile, preboot-accessible portion of a memory of the information handling system.

13. The method of claim 12, further comprising retrieving the firmware update image for performing the firmware update from a firmware deployment service remotely networked to the information handling system and staging the firmware update image in the non-volatile, preboot-accessible portion of the memory until the firmware update is applied.

14. The method of claim 8, wherein the prescription is set forth in a prescription payload comprising one or more prescriptions and stored in a non-volatile, preboot-accessible portion of a memory of the information handling system.

15. An article of manufacture comprising:
a non-transitory computer-readable medium; and
computer-executable instructions carried on the computer-readable medium, the instructions readable by a processor, the instructions, when read and executed, for causing the processor to:
monitor diagnostics information associated with one or more information handling resources of an information handling system;
from the diagnostics information, determine whether a trigger point associated with a prescription for initiating a firmware update has been reached; and
responsive to the trigger point being reached, perform a remedial action as defined by the prescription.

16. The article of claim 15, wherein performing the remedial action comprises:
responsive to the trigger point being reached, communicating a notification defined by the prescription to a person;
determining whether the remedial action is chosen by the person or dictated by a policy of the information handling system; and
responsive to the remedial action being chosen by the person or dictated by the policy of the information handling system, performing the remedial action.

17. The article of claim 15, wherein the remedial action comprises application of a firmware update to an information handling resource of the information handling system.

18. The article of claim 17, wherein the information handling resource is the BIOS.

19. The article of claim 17, the instructions for further causing the processor to stage a firmware update image for performing the firmware update in a non-volatile, preboot-accessible portion of a memory of the information handling system.

20. The article of claim 19, the instructions for further causing the processor to retrieve the firmware update image for performing the firmware update from a firmware deployment service remotely networked to the information handling system and stage the firmware update image in the non-volatile, preboot-accessible portion of the memory until the firmware update is applied.

21. The article of claim 15, wherein the prescription is set forth in a prescription payload comprising one or more prescriptions and stored in a non-volatile, preboot-accessible portion of a memory of the information handling system.
